(19) United States
(12) Patent Application Publication
(10) Pub. No.: US 2026/0258644 A1
(43) Pub. Date: Sep. 3, 2026

(54) AERATOR, OUTLET ASSEMBLY, AND METHOD FOR ASSEMBLING AND DISASSEMBLING AN AERATOR

(71) Applicant: Neoperl GmbH, Müllheim (DE)

(72) Inventor: Alexander Stein, Ihringen (DE)

(73) Assignee: Neoperl GmbH, Müllheim (DE)

(21) Appl. No.: 18/846,729

(22) PCT Filed: Mar. 14, 2023
(86) PCT No.: PCT/EP2023/056471

§ 371 Date: Sep. 13, 2024

(30) Foreign Application Priority Data
Mar. 16, 2022 (DE) 20 2022 101 391.8

(51) Int. Cl. E03C 1/084; B05B 1/18; B05B 7/04

(52) U.S. Cl. CPC E03C 1/084; B05B 1/182; B05B 7/0416

(57) ABSTRACT

In an aerator (2) having a disassembly unit (8) and an external application point (17) for attachment in a water flow, in which a housing part (6) that has an outlet structure (7) is attached to the disassembly unit (8) at an attachment point (10), it is provided that the housing part (6) is at least in part made of an elastic material.

### CROSS-REFERENCE TO RELATED APPLICATION

This application is a 371 National Phase of PCT/EP2023/056471, filed Mar. 14, 2023, which claims priority from German Patent Application No. 20 2022 101 391.8, filed Mar. 16, 2022, both of which are incorporated herein by reference as if fully set forth.

### TECHNICAL FIELD

The invention relates to an aerator which comprises a disassembly unit with an external application point for attachment in a water flow, wherein a housing part has an outlet structure and is attached to the disassembly unit at an attachment point. Such an aerator is widely used in practice.

The invention also relates to a method for assembling and disassembling an aerator. Such a method is known.

The invention also relates to an outlet assembly with an aerator and an assembly sleeve. Such an outlet assembly is known.

### SUMMARY

The object of the invention is to extend the service life of an aerator. A further object of the invention is to provide an aerator in which limescale formation can be very easily removed by hand. A further object of the invention is to reduce material costs and manufacturing complexity. The object is achieved by one or more of the features disclosed herein. Advantageous embodiments are described below and in the claims.

It should be noted that the features listed individually in the dependent claims can be combined with one another in any technically feasible manner and define further embodiments of the invention. In addition, the features specified in the claims are further specified and explained in the description, wherein further preferred embodiments of the invention are presented.

To achieve this object, the invention proposes one or more of the features disclosed herein 1. In particular, it is thus proposed in accordance with the invention for an aerator of the type described at the outset to achieve the stated object in that the housing part is at least in part made of an elastic material. As a result, limescale formation on the housing part can simply be rubbed off or removed by hand.

The application point can be designed as a preferably closed circumferential rib. Alternatively, the application point can also be designed as part of a thread.

Advantageous embodiments of the invention are described below, which can optionally be combined with one or more of the features alone or in combination with the features of other embodiments.

In an advantageous embodiment, it can be provided that the attachment point is downstream of the application point. In this way, improved mechanical stability can be achieved.

The disassembly unit can be understood as a generic term and can, for example, comprise a diffuser unit and a disassembly plate as variants. The diffuser unit can have a diffuser and a diffuser ring. For example, a disassembly unit can be characterized as a functional unit that decouples a flow behavior within the aerator from a flow behavior upstream of the aerator.

In an advantageous embodiment, the housing part can be designed to be elastic in one area of the wall. It is advantageous if the wall can be elastically deformable in this area. The wall can also be cylindrical. This makes it relatively easy to remove limescale formation manually, especially locally.

In an advantageous embodiment, it can be provided that the elastic material is a rubber or a silicone or a thermoplastic elastomer. This provides a cost-effective material that can reduce the overall material costs of the aerator.

In an advantageous embodiment, it can be provided that the application point can provide an integrally bonded and/or frictionally engaged and/or form-fitting connection. This makes it possible to provide a connection that is easy to create structurally.

In an advantageous embodiment, it can be provided that the outlet structure has webs and/or rings on the outflow side. The webs are preferably parallel, for example to form a rectangular lattice, or branched in a net-like manner, for example to form a hexagonal lattice. The webs are pronounced in the axial direction, wherein their dimensions are greater in the axial direction than in the radial direction. In this way, stabilization of the outlet structure can be provided so that deformation of the outlet structure does not negatively affect the jet pattern.

Alternatively or additionally, the outlet structure can also have rings on the downstream side. This means that outlet structures can be provided that have several concentric rings, for example, in particular connected to radially extending webs.

The rings or webs can be of different thicknesses in order to achieve local reinforcement of the bending line as required.

For this purpose, the webs or rings can be of different heights or lengths.

In an advantageous embodiment, it can be provided that the webs and/or rings have a cross-section that tapers in the flow direction. This is favorable for the recombination of the individual jets that emerge from the outlet structure. In this way, a uniform and dynamic jet pattern can be achieved.

In an advantageous embodiment, the outlet structure can be reinforced with ribs on the inflow side. The ribs can be designed as transverse webs, wherein the transverse webs can be shorter than the longitudinal webs. In this way, the outlet structure can be stabilized so that the jet pattern is not negatively affected under water pressure. The ribs can be made of the elastic material, for example.

In an advantageous embodiment, it can be provided that the housing part is made of the elastic material at least in a wall area upstream of the outlet structure. This means that an axial length of the housing part can be easily reduced by deformation. It is preferable that the wall area is made of the elastic material all the way around and/or in its entire axial extent. Here, the terms “axial”, “radial” and/or “circumferential” and/or “longitudinal” and/or “transverse” can refer, for example, to an insertion direction and/or a longitudinal axis of the aerator.

In an advantageous embodiment, it can be provided that the outlet structure is made of an elastic material, preferably a rubber or a silicone or a thermoplastic elastomer. Alternatively or additionally, the outlet structure can be formed in one piece with the housing part. This means that limescale can be removed simply by being rubbed off by hand.

In an advantageous embodiment, it can be provided that the housing part has a thickening which provides a radial seal that acts outwards, for example towards an external assembly sleeve or a fitting, and/or inwards towards the disassembly unit, in particular a disassembly plate. In this way, a seal can be easily provided and/or a thread can be sealed on both sides. Preferably, the thickening is pronounced at the upper end of the housing part. An additional sealing ring is therefore unnecessary.

In an advantageous embodiment, it can be provided that the outlet structure has a concave shape on the inflow side. This provides a stable shaping that reduces deformation under the prevailing water pressure.

Preferably, the aerator has an outlet structure that is substantially adapted to the load.

In an advantageous embodiment, it can be provided that the outlet structure has a convex shape on the inflow side. This provides a stable shaping that reduces deformation under the prevailing water pressure.

In an advantageous embodiment, it can be provided that the disassembly unit is made of a more rigid material than the outlet structure. This provides greater stability for the aerator.

A disassembly unit typically comprises a diffuser and a diffuser ring or a disassembly plate.

In an advantageous embodiment, it can be provided that the outlet structure and/or the connected cylindrical area of the sleeve is/are manually deformable at least inwards. The outlet structure can be easier to deform inwards than outwards. This can be the case, for example, if the user attempts to contact tool contact surfaces with a tool. This provides easier access to the tool contact surfaces and allows a variety of tools to be used. One conceivable tool could be a coin, for example.

In an advantageous embodiment, it can be provided that the housing part has ventilation openings. This allows air to be easily drawn in and mixed with the water jet, resulting in a visually appealing jet pattern.

In an advantageous embodiment, it can be provided that the disassembly unit preferably reaches through the ventilation openings from the inside. The disassembly unit can also grip through the ventilation openings from the outside. This can provide a stable basic shape and prevent the housing part from sliding downwards under the water pressure.

In an advantageous embodiment, it can be provided that the disassembly unit has an attachment point. This enables a simple connection between the disassembly unit and the housing part.

The attachment point(s) can create a snap connection, wherein the angles of inclination of the snap connection can be selected, for example, so that either an angle of less than 90° or equal to 90° is included or at least a self-locking hold is ensured.

The attachment point or attachment points can alternatively or additionally be limited in the circumferential direction. The existence of ventilation openings is not mandatory; however, such ventilation openings can be used to accommodate attachment points that are limited in the circumferential direction.

In an advantageous embodiment, it can be provided that a lateral projection of a contact surface for a mouthpiece or assembly sleeve beyond the attachment point is smaller than or equal to a thickening of the housing part at the attachment point. This prevents the housing part from slipping downwards under the prevailing water pressure and/or from changing its position, as it does not fit through an annular gap that forms between the attachment point and the assembly sleeve due to the projection.

In an advantageous embodiment, it can be provided that the disassembly unit comprises a diffuser and a diffuser ring. In this way, an optically advantageous jet pattern can be provided.

In an advantageous embodiment, it can be provided that the housing part engages in a groove of the diffuser ring on the inflow side. This allows the housing part to be stabilized in its position and prevents the housing part from slipping downwards under the water pressure. In an advantageous embodiment, it can be provided that an insert part is arranged between the disassembly unit and the outlet structure. Preferably, the insert part is designed as one or more insert grids. The insert part can also take the form of one or more molded parts. This can increase the mechanical stability of the aerator and improve the jet pattern.

The insert part is preferably plugged into the outlet structure.

Preferably, the insert part has upwardly projecting prongs and/or spikes, which ensure that the water is mixed. These prongs and/or spikes can, for example, only be connected to each other at their base points. This makes it possible to achieve deformability in a direction in which the free ends of the prongs and/or spikes can move away from each other, while the prongs and/or spikes are supported against each other in the opposite direction and do not allow any deformation.

For example, these upwardly projecting prongs or spikes can be formed on an otherwise elastic outlet structure and stabilize it downwards by supporting each other.

In an advantageous embodiment, the insert part can be rigid or elastically deformable. In a rigid design variant, the outlet structure can thus be stabilized or stiffened. In an elastic embodiment, the elastic deformations therefore cannot be hindered, which has an advantageous effect.

To achieve the stated object, the features of the coordinated claim directed to a method for assembling and disassembling an aerator are provided according to the invention. In particular, in order to achieve the stated object, it is thus proposed according to the invention in a method of the type described at the outset that a tool is inserted into grooves or tool engagement surfaces so that an outlet structure of the aerator is elastically deformed. This means that a large number of different tools can be used, as the outlet structure and/or overlying geometric parts made of rubber are elastically deformable. For example, it may also be possible to use a coin as a tool.

One advantage of the invention is that the outlet structure can project axially beyond a tool engagement surface without impairing the functionality of the tool engagement surface. The projection has the advantage of simplified cleaning.

To achieve the stated object, one or more of the features directed to an outlet assembly are provided alternatively or additionally according to the invention. In particular, in order to achieve the stated object, it is thus proposed according to the invention, in the case of an outlet assembly having an aerator according to one of the aforementioned features and an assembly sleeve for attaching the aerator, that a tool engagement surface is provided on the outflow side of the assembly sleeve, by means of which tool engagement surface the assembly sleeve can be assembled and disassembled by a rotational movement and/or linear movement. Preferably, a housing part projects beyond the tool contact surface. A robust structure can thus be provided.

According to the invention, it can be provided that the outlet assembly comprises an aerator and an assembly sleeve for attaching the aerator, wherein a tool engagement surface is provided on the outflow side of the assembly sleeve, with which the assembly sleeve can be assembled and disassembled, and wherein a housing part of the aerator can be elastically deformed until the tool engagement surface is accessible for a tool. This means that numerous tools can be used and special tool manufacture is no longer necessary. Special tools are no longer required due to the yielding housing part.

In an advantageous embodiment, it can be provided that the aerator is arranged on a support shoulder of the assembly sleeve. This ensures optimum attachment and accessibility of the outlet structure and thus the cleanability of the outlet structure in everyday operation.

In one embodiment of the invention, it can be provided that a mold parting line is arranged on an inflow side of the outlet structure. This makes it easy to manufacture an outlet structure using injection molding technology for which the mold elements, in particular webs or ribs, have a cross-section that decreases in the flow direction. The mold parting line can be characterized, for example, as a structure running around the workpiece, which results from a parting line of an injection mold.

### BRIEF DESCRIPTION OF THE DRAWINGS

The invention will now be described in greater detail with reference to a few exemplary embodiments, but is not limited to these few exemplary embodiments. Further variants of the invention and embodiments result from combining the features of individual or several protective claims with one another and/or with individual or several features of the exemplary embodiments and/or the variants of devices and methods according to the invention described above.

In the drawings:

FIG. 1 shows a sectional view of an outlet assembly,

FIG. 2 shows a sectional view of the aerator from the front,

FIG. 3 shows a perspective view of the disassembly housing and housing part,

FIG. 4 shows the aerator of FIG. 2 in a view from the front,

FIG. 5 shows a sectional view of an outlet assembly in a fitting,

FIG. 6 shows a perspective view of the outlet assembly in FIG. 5,

FIG. 7 shows a sectional view of an outlet assembly in a fitting,

FIG. 8 shows a perspective view of the outlet assembly in FIG. 7,

FIG. 9 shows a sectional view of the aerator from the side,

FIG. 10 shows a perspective view of a diffuser ring of a disassembly unit and a housing part,

FIG. 11 shows a sectional view of an outlet assembly from the side,

FIG. 12 shows a perspective view of the outlet assembly in FIG. 11,

FIG. 13 shows an outlet assembly in a perspective view and with a tool,

FIG. 14 shows the outlet assembly of FIG. 13 in a perspective view and with a tool,

FIG. 15 shows the outlet assembly of FIG. 13 and FIG. 14 in a perspective view and with a tool and outlet structure deformed thereby,

FIG. 16 shows a sectional view of an outlet assembly from the side,

FIG. 17 shows a perspective view of the outlet assembly in FIG. 16,

FIG. 18 shows a perspective view of a disassembly unit with disassembly plate and a housing part,

FIG. 19 shows the disassembly plate and the housing part from FIG. 18 in a further perspective view,

FIG. 20 shows a sectional view of an outlet assembly from the side,

FIG. 21 shows a perspective view of the outlet assembly in FIG. 20,

FIG. 22 shows a disassembly plate of a disassembly unit and a housing part in a perspective view,

FIG. 23 shows a perspective view of the disassembly plate and the housing part of FIG. 22.

### DETAILED DESCRIPTION

In the following description of various exemplary embodiments of the invention, elements with the same function are given the same reference numerals even if they have a different design or shape.

For the sake of clarity, not all reference signs are shown in the Figures, although the elements may very well be present in the Figures. However, identical reference signs denote functionally and/or structurally identical components and functional units.

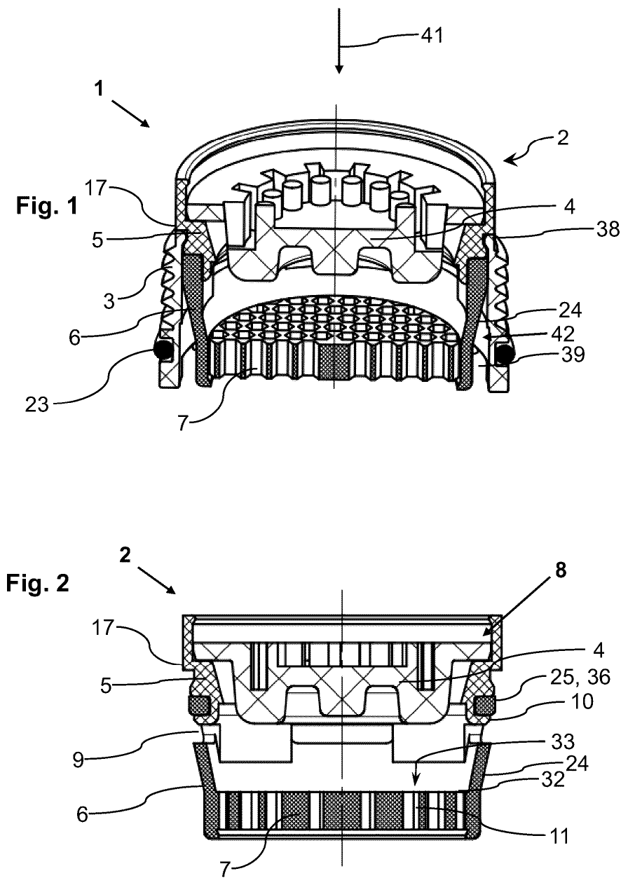

FIG. 1 shows a sectional view of an outlet assembly 1. The outlet assembly 1 comprises an aerator 2 and an assembly sleeve 3. The aerator 2 has a diffuser 4 and a diffuser ring 5. The aerator 2 also has a housing part 6, which is made of an elastic material overall and thus also in its wall area 24. Preferably, the elastic material is a rubber or a silicone or a thermoplastic elastomer. The housing part 6 comprises an outlet structure 7. The wall area 24 extends over the entire circumference of the aerator 2 and also over the entire (axial) height of the housing part 6 upstream or above the outlet structure 7.

The assembly sleeve 3 comprises a sealing ring 23, which is arranged radially.

The elastic housing part 6 has a sealing function, as it lies tightly against the diffuser ring 5 and is held in position by the assembly sleeve 3. The elastic housing part 6 can be elastically pre-stressed in relation to the diffuser ring 5. The elastic housing part 6 lies tightly against the assembly sleeve 3, wherein the diffuser ring 5 forms a counter-sealing surface. The elastic housing part 6 is held in position by the disassembly unit 8 by means of the attachment points 10 on the one hand and the assembly sleeve 3 on the other. The sealing function works both inwards and outwards at the same time.

FIG. 2 shows an aerator 2 in a sectional view from the front. The aerator 2 has a housing part 6 with an outlet structure 7 and a disassembly unit 8. The disassembly unit 8 comprises a diffuser 4 and a diffuser ring 5. The disassembly unit 8 is made of a stiffer material than the outlet structure 7. The outlet structure 7 can be made of an elastic material, for example a rubber or a silicone or a thermoplastic elastomer. The housing part 6 has ventilation openings 9. The disassembly unit 8 preferably engages from the inside through the ventilation openings 9. The assembly sleeve 3 is not shown in FIG. 2, but is present. The disassembly unit 8 has an attachment point 10. A lateral projection of a contact surface 25 for a mouthpiece or an assembly sleeve 3 beyond the attachment point 10 is smaller than a material thickness of the housing part 6. The outlet structure 7 has webs 11 in the radial direction. The webs 11 are intended to give the outlet structure 7 a certain stability so that deformation of the outlet structure 7 by the water pressure is reduced. As an alternative to the webs 11, the outlet structure 7 can have rings 31. The webs 11 are preferably parallel or branched in a net-like manner.

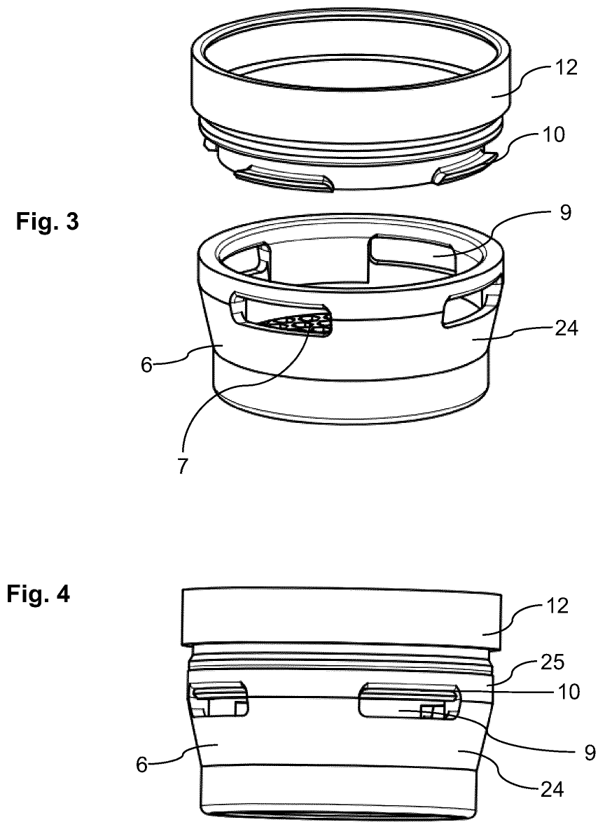

FIG. 3 shows a perspective view of a disassembly housing 12 and a housing part 6. The disassembly housing 12 has attachment points 10, which can preferably engage from the inside through the ventilation openings 9 of the housing part 6. FIG. 4 shows the aerator from the front, wherein the disassembly housing 12 and the housing part 6 are assembled together.

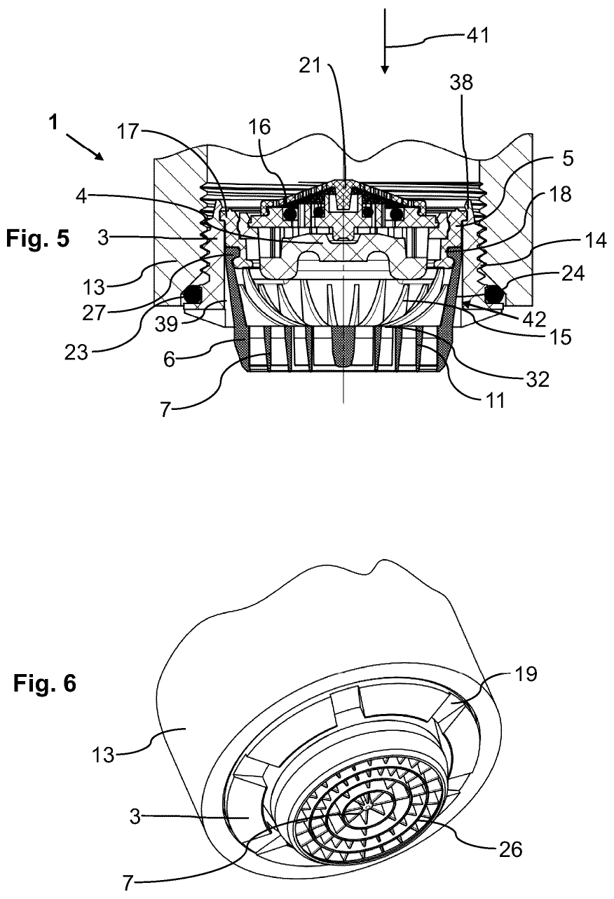

FIG. 5 shows a sectional view of an outlet assembly 1 in a fitting 13. The outlet assembly 1 comprises an aerator 2 and an assembly sleeve 3. The assembly sleeve 3 has a sealing ring 23, which is arranged radially on the assembly sleeve 3 and contacts and seals the fitting 13. The diameter of the sealing ring 23 is larger than the diameter of the thread 14 of the assembly sleeve 3. The assembly sleeve 3 can also be designed as a mouthpiece. The housing part 6 has ribs 15 which stiffen the outlet structure 7. The outlet structure 7 is also made of an elastic material, for example a rubber or a silicone or a thermoplastic elastomer, and can be formed in one piece with the housing part 6. The aerator 2 also has a flow regulator 16, which generates/defines a specific flow/pressure curve. The diffuser ring 5 has an external application point 17, which rests on a support shoulder 38 of the assembly sleeve 3. The housing part 6 engages in a groove 18 of the diffuser ring 5 on the inflow side. The housing part 6 can also serve as a radial seal to a mouthpiece or to the assembly sleeve 3; this saves a separate seal or tight tolerances and high surface requirements for a seal between hard materials.

FIG. 6 shows the outlet assembly 1 from FIG. 5 in a perspective view from below. On the outflow side, tool contact surfaces 19 can be seen, on which tools can engage. As the outlet structure 7 is made of an elastic material, it can be deformed when a tool engages with the tool contact surfaces 19. A number of different tools are also conceivable, for example a coin. This eliminates the need to design and provide special tools, which is a logistical and financial burden.

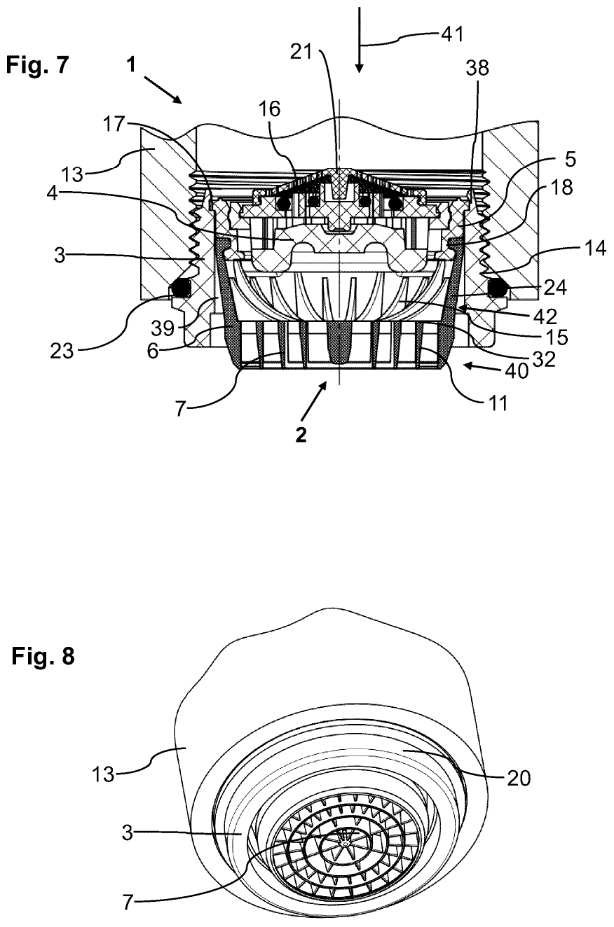

FIG. 7 shows a sectional view of an outlet assembly 1 in a fitting 13. The outlet structure 7 has ribs 15 that stabilize the outlet structure. The ribs 15 engage with the webs 11 and strengthen them. The webs 11 are preferably parallel or branched in a net-like manner. The idea here is that the entire outlet structure is stabilized so that it does not deform or deforms only slightly under water pressure and produces an appealing jet pattern.

FIG. 8 shows a perspective view of the outlet assembly 1 from FIG. 7. In contrast to FIG. 6, there are no tool contact surfaces 19 here, but a gripping surface 20. The gripping surface 20 can be rotated in order to turn the inner assembly sleeve 3 in or out.

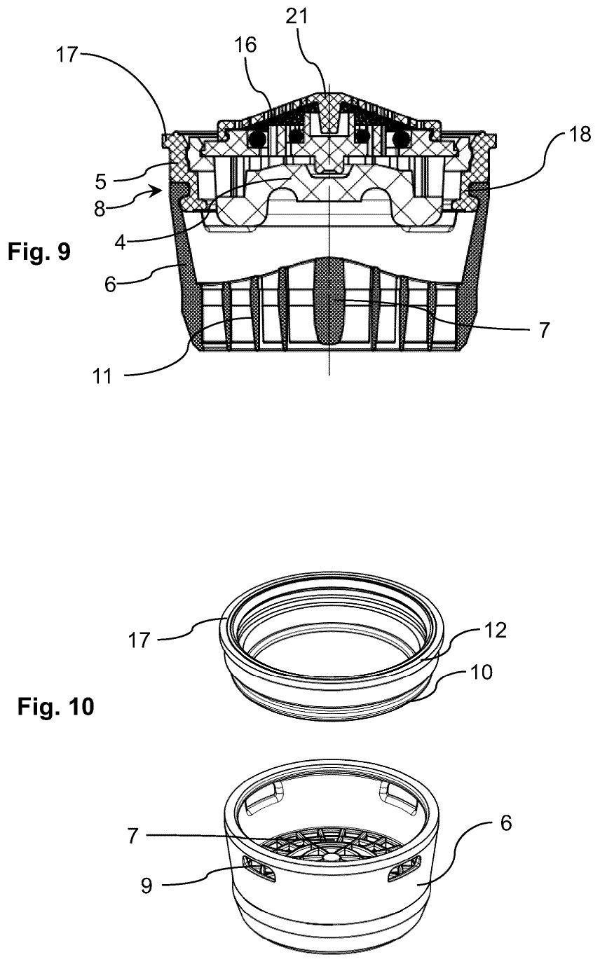

FIG. 9 shows an aerator in a sectional view from the side. The outlet structure 7 has a convex shape. The convex shape ensures that the deformation of the housing part 6 mainly takes place on the wall and that an appealing jet pattern can still be generated. FIG. 10 shows an exploded view of FIG. 9 with a diffuser ring 5 of a disassembly unit 8 and a housing part 6 in perspective view from above. The housing part 6 has ventilation openings 9, which can draw in air during operation, wherein the air combines with the water jet and results in a specific jet pattern. The disassembly housing 12 has a circumferential attachment point 10, which can be designed as a snap connection. The disassembly housing 12 also has an application point 17, which is designed as a circumferential rib.

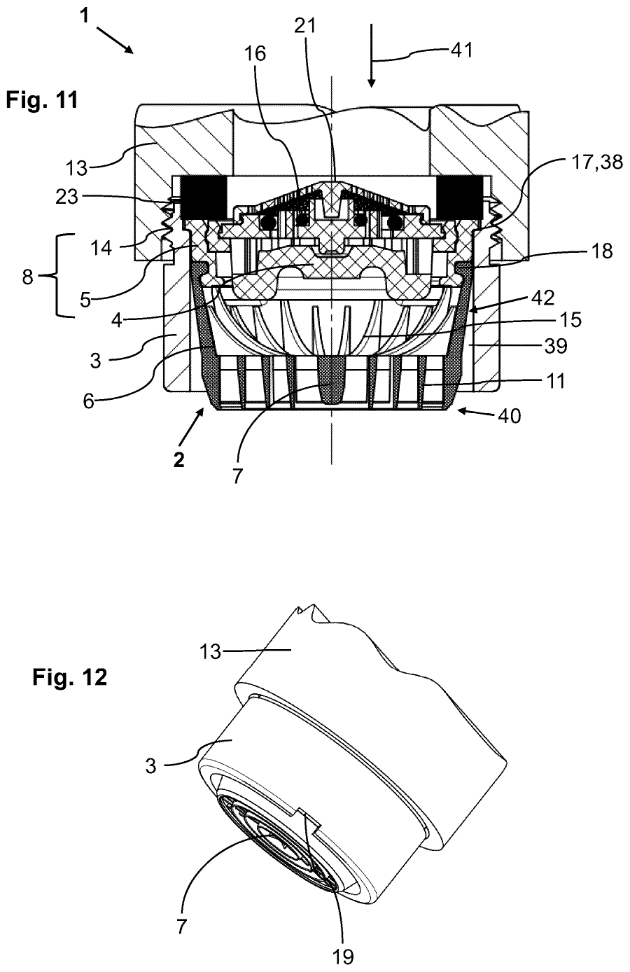

FIG. 11 shows an outlet assembly 1 in a sectional view from the side and in a fitting 13. Ribs 15 reinforce the outlet structure 7. A sealing ring 23 is arranged on the diffuser ring 5 and seals the disassembly unit 8 against the fitting 13. In the embodiments shown so far, the sealing ring 23 was fitted on the assembly sleeve 3 and sealed the assembly sleeve 3 against the fitting 13. The aerator 2 has an attachment screen 21 and a flow regulator 16. The diffuser 4 is arranged inside the diffuser ring 5. The housing part 6 engages in a groove 18 of the diffuser ring 5. The thread 14 of the assembly sleeve 3 is arranged on the inflow side. FIG. 12 shows the outlet assembly 1 from FIG. 11 in a perspective view from the side. A tool contact surface 19 is visible. The outlet structure 7 of the housing part 6 is deformable so that a variety of tools can be used. Separate production of special tools is no longer necessary. The special tools are an additional burden in terms of manufacturing costs and it is an organizational and logistical challenge to keep the special tools available at all times.

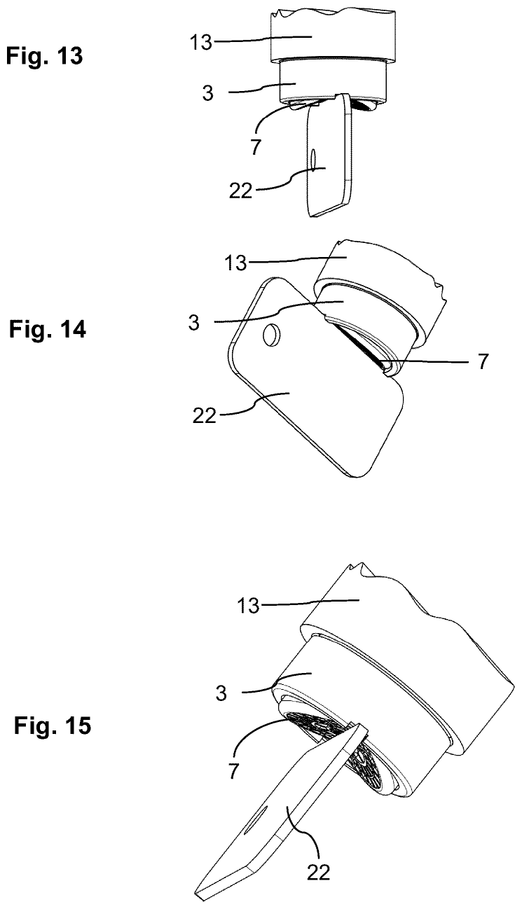

FIG. 13 to FIG. 15 show the outlet assembly 1 in a perspective view and with a tool 22. The deformed outlet structure 7 can be seen in FIG. 13 to FIG. 15. The tool 22 is shown here as a plate. Other shapes of tools 22 are also conceivable, for example a round or coin shape. The wall area 24 (not shown here) can be made of an elastic material upstream of the outlet structure 7 and can also be deformable. FIG. 15 shows the deformed outlet structure 7 and the deformed wall or wall area 24 (not visible here due to the representation of the fitting 13 and the assembly sleeve 3).

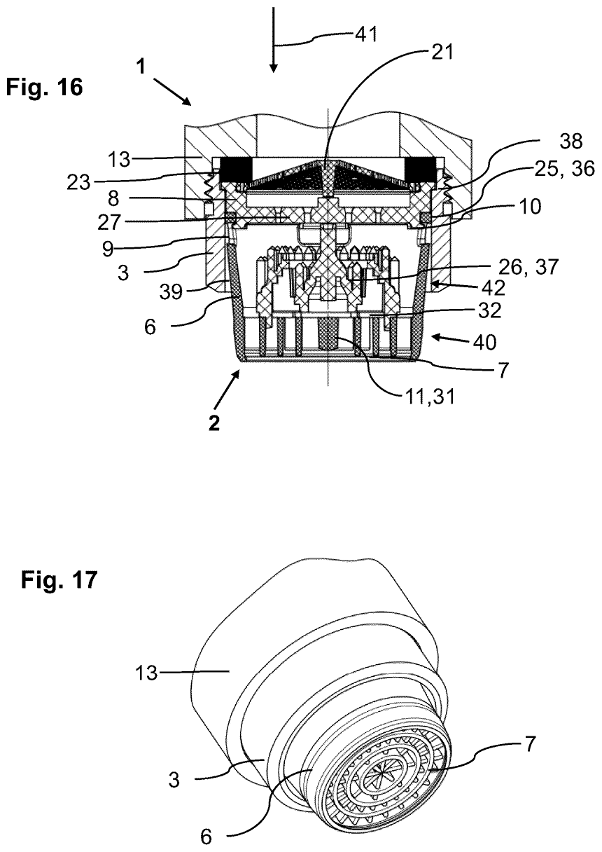

FIG. 16 shows an outlet assembly 1 in a sectional view from the side. The outlet assembly comprises a housing part 6, an outlet structure 7, an attachment screen 21, a disassembly plate 27 and an insert part 26. The insert part 26 is located between the outlet structure 7 and the disassembly plate 27 and is plugged into the outlet structure 7. The housing part 6, which is made of an elastic material, has ventilation openings 9, which ensure air mixing during operation of the aerator and thus provide a regular and visually appealing jet pattern. The insert 26 is plugged into the outlet structure 7, but can also be molded onto it, and increases stability in one load direction, namely in the direction of the flow. The insert part 26 has upwardly projecting prongs or spikes, which ensure mixing of the water. The insert part 26 can be segmented in order to allow the housing part 6 to move in at least one direction. The insert part 26 can either be rigid, for example to stabilize or stiffen the outlet structure 7, or can be elastic itself so as not to hinder the elastic deformations. The insert part 26 can also have a shape other than that shown here. The outlet assembly 1 also has a sealing ring 23, which seals the fitting 13, the assembly sleeve 3 and the disassembly plate 27. The outlet assembly 1 also has one or more attachment points 10, which engage in the ventilation openings 9 and project from the disassembly plate 27. The attachment points 10 enable the correct angular alignment of the disassembly plate 27 the housing part 6. The outlet structure 7 has webs 11 or rings, which are arranged on the water outlet. The webs 11 are preferably parallel or branched in a net-like manner.

The insert part 26 can be more rigid than a base of the housing part 6 for compression transverse to the flow direction on the one hand and for deflection in the flow direction on the other.

The insert part 26 can also be inserted with a range of movement so that the insert part 26 can be lifted off when the base of the housing part 6 is deformed.

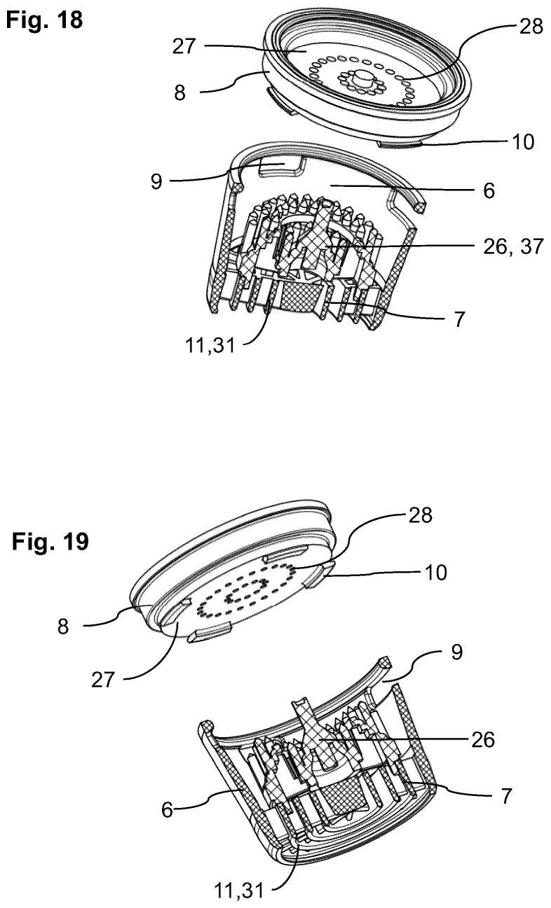

FIG. 17 shows a perspective view of the outlet assembly from the outside (on the valve side). FIGS. 18 and 19 show a perspective view of the disassembly plate 27 and the housing part 6. The disassembly plate 27 has disassembly openings 28 and outwardly projecting attachment points 10. An insert part 26 is arranged inside the housing part 6 and is inserted into the outlet structure 7. The attachment points 10 ensure the correct angular alignment of the disassembly plate 27 within the housing part 6, and the insert 26 can make direct contact with the disassembly openings 28 in an assembled arrangement. This results in further jet fragmentation and therefore better homogenization of the water jet.

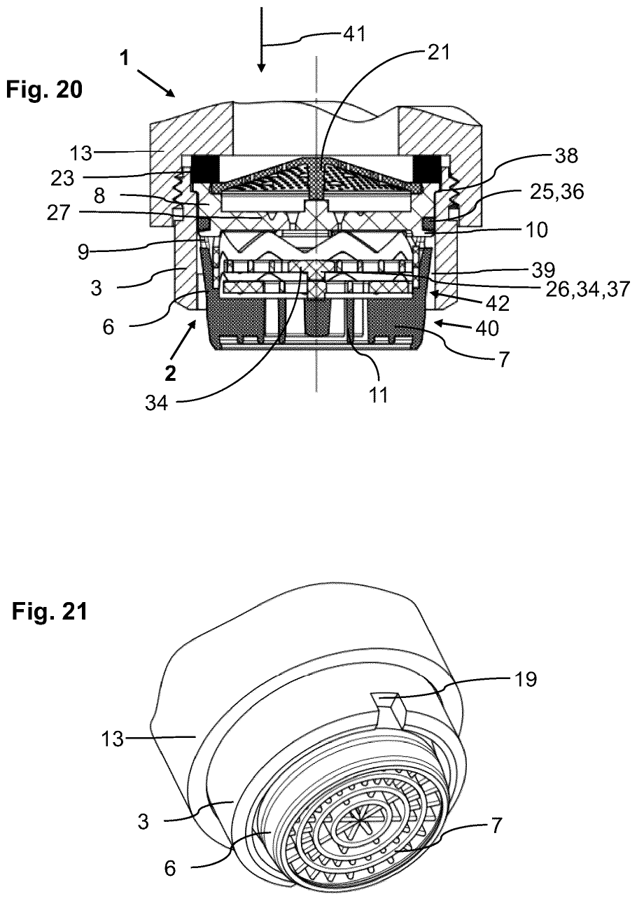

FIG. 20 shows another outlet assembly 1 in a sectional view from the side. The outlet assembly 1 in FIG. 20 has similar components to the outlet assembly 1 in FIG. 16. One difference is that the outlet assembly in FIG. 20 has at least one insert grid 34. The housing part 6 is at least in part made of an elastic material, preferably a rubber or a silicone or a thermoplastic elastomer. The aerator 1 is arranged on a support shoulder 38 of the assembly sleeve 3.

FIG. 21 shows an outlet assembly 1 in a perspective view from the outside on the fitting side. A tool engagement surface 19 is provided, into which a tool 22 can engage in order to loosen or attach the assembly sleeve 3. Since the housing part 6 is made of an elastic material, it is deformable so that a number of different tools 22 can engage with the tool engagement surface 19.

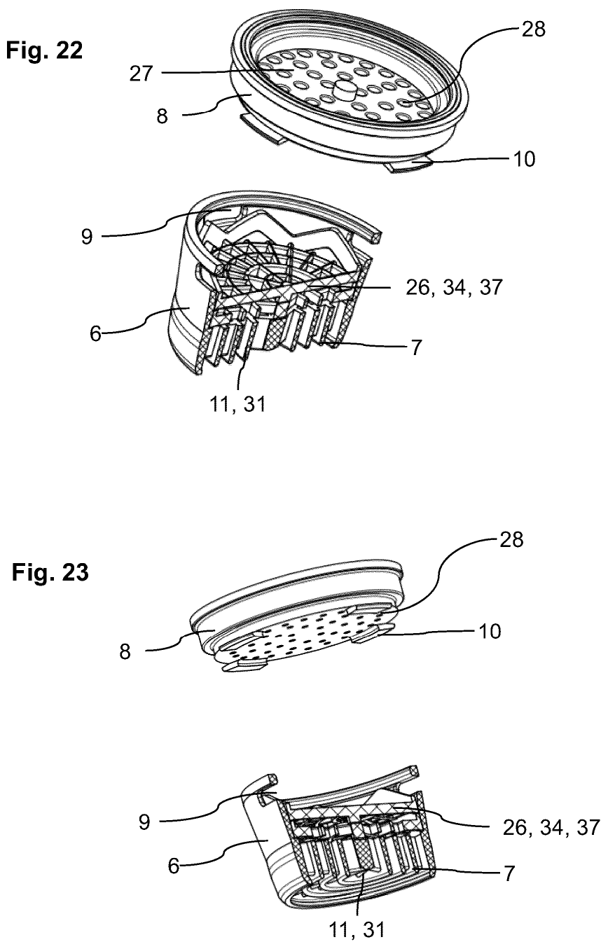

FIG. 22 and FIG. 23 show a perspective view of the housing part 6 and the disassembly plate 27. The housing part 6 has an insert part 26 designed as an insert grid 34. The attachment points 10 can be designed as snap connections. An insert part 26 is formed in the housing part 6 and is arranged on the outlet structure 7.

There can also be several insert parts 26 provided. The strength of the insert part 26 can provide further stabilization if the housing part 6 is too yielding or too flexible.

FIG. 5 also shows that a mold parting line 32, which is created by at least two injection mold parts that touch each other during injection molding, is arranged at the level of the inflow side 33 of the outlet structure 7. Thus, the tool that forms the webs 11 of the outlet structure 7 is demolded in the flow direction. Therefore, the webs 11 are formed with a cross-section or profile that has a decreasing dimension in the flow direction.

In an aerator 2 comprising a disassembly unit 8 and an external application point 17 for attachment in a water flow, wherein a housing part 6 has an outlet structure 7 and is attached to the disassembly unit 8 at an attachment point 10, it is proposed that the housing part 6 is at least in part made of an elastic material.

### LIST OF REFERENCE SIGNS

1 outlet assembly
2 aerator
3 assembly sleeve
4 diffuser
5 diffuser ring
6 housing part
7 outlet structure
8 disassembly unit
9 ventilation openings
10 attachment point
11 webs
12 disassembly housing
13 fitting
14 thread
15 ribs
16 flow regulator
17 application point
18 groove
19 tool contact surface
20 gripping surface
21 attachment screen
22 tool
23 sealing ring
24 wall area
25 contact surface
26 insert part
27 disassembly plate
28 disassembly openings
31 rings
32 mold parting line
33 inflow side
34 insert grid
35 (other) insert grid
36 thickening
37 molded parts
38 support shoulder

1. An aerator (2) comprising:
a disassembly unit (8) with an external application point (17), for attachment in a water flow;
a housing part (6) having an outlet structure (7) attached to the disassembly unit (8) at an attachment point (10); and
the housing part (6) is at least in part made of an elastic material.

2. The aerator (2) as claimed in claim 1, wherein the attachment point (10) is downstream of the application point (17).

3. The aerator (2) as claimed in claim 1, wherein the housing part (6) is elastically formed in a region of a wall thereof such that the wall is elastically deformable in said region.

4. The aerator (2) as claimed in claim 1, wherein the elastic material is a rubber or a silicone or a thermoplastic elastomer.

5. The aerator (2) as claimed in claim 1, wherein the application point provides at least one of an integrally bonded, frictionally engaged, or form-fitting connection.

6. The aerator (2) as claimed in claim 1, wherein the outlet structure (7) has at least one of branched webs (11) or rings (31) on an outflow side.

7. The aerator (2) as claimed in claim 6, wherein the at least one of the webs (11) or rings (31) have a cross-section tapering in the flow direction.

8. The aerator (2) as claimed in claim 1, further comprising ribs (15) on an inflow side of the outlet structure (7) for stiffening.

9. The aerator (2) as claimed in claim 1, wherein the housing part (6) is made of the elastic material at least in a wall region (24) upstream of the outlet structure (7).

10. The aerator (2) as claimed in claim 1, wherein the outlet structure (7) is at least one of made of an elastic material or formed in one piece with the housing part (6).

11. The aerator (2) as claimed in claim 1, wherein the housing part (6) has a thickening (36) which provides a radial seal which has at least one of a radially inward or radially outward sealing effect.

12. The aerator (2) as claimed in claim 1, wherein the outlet structure (7) has a concave shape on an inflow side.

13. The aerator (2) as claimed in claim 1, wherein the outlet structure (7) has a convex shape on an inflow side.

14. The aerator (2) as claimed in claim 1, wherein the disassembly unit (8) is made of a stiffer material than the outlet structure (7).

15. The aerator (2) as claimed in claim 1, wherein the outlet structure (7) is manually deformable at least inwards.

16. The aerator (2) as claimed in claim 1, wherein the housing part (6) has ventilation openings (9).

17. The aerator (2) as claimed in claim 16, wherein the disassembly unit (8) preferably engages the housing part (6) from inside through the ventilation opening (9).

18. The aerator (2) as claimed in claim 1, wherein the disassembly unit (8) has the attachment point (10).

19. The aerator (2) as claimed in claim 1, wherein a lateral projection of a contact surface (25) for a mouthpiece beyond the attachment point (10) is smaller than or equal to a thickening (36) of the housing part (6) at the attachment point (10).

20. The aerator (2) as claimed in claim 1, wherein the disassembly unit (8) comprises at least one of a) a diffuser (4) and a diffuser ring (5) or b) a disassembly plate.

21. The aerator (2) as claimed in claim 20, wherein the disassembly unit (8) comprises the diffuser (4) and the diffuser ring (5), and the housing part (6) engages in a groove (18) of the diffuser ring (5) on an inflow side.

22. The aerator (2) as claimed in claim 1, further comprising an insert part (26) arranged between the disassembly unit (8) and the outlet structure (7).

23. The aerator (2) as claimed in claim 22, wherein the insert part (26) is rigid or elastically deformable.

24. A method for assembling and disassembling an aerator (2),
inserting a tool (22) into grooves or tool engagement surfaces (19) of the aerator so that an outlet structure (7) of the aerator (2) is elastically deformed.

25. An outlet assembly (1), comprising:
the aerator (2) as claimed in claim 1, and
an assembly sleeve (3) for attaching the aerator (2), the assembly sleeve (3) including a tool engagement surface (19) on a downstream side by which tool engagement surface the assembly sleeve (3) is adapted to be assembled and disassembled by at least one of a rotational movement or linear movement.

26. An outlet assembly (1), comprising
the aerator (2) as claimed in claim 1,
an assembly sleeve (3) for attaching the aerator (2), the assembly sleeve (3) including a tool engagement surface (19) on an outflow side by which tool engagement surface the assembly sleeve (3) is adapted to be assembled and disassembled; and
the housing part (6) of the aerator (2) is elastically deformable until the tool engagement surface (19) is accessible to a tool.

27. The outlet assembly (1) as claimed in claim 26, wherein the aerator (2) is arranged on a support shoulder (38) of the assembly sleeve (3).

28. The outlet assembly (1) as claimed in claim 26, wherein a mold parting line (32) is arranged on an inflow side (33) of the outlet structure (7).
